(19) United States
(12) Patent Application Publication
(10) Pub. No.: US 2020/0216046 A1
(43) Pub. Date: Jul. 9, 2020

(54) VEHICLE CONTROL DEVICE

(71) Applicant: Hitachi Automotive Systems, Ltd., Hitachinaka-shi, Ibaraki (JP)

(72) Inventors: Naoki HIRAGA, Hitachinaka-shi, Ibaraki (JP); Seiichi SATOH, Hitachinaka-shi, Ibaraki (JP); Toshiyuki INNAMI, Hitachinaka-shi, Ibaraki (JP); Junya TAKAHASHI, Chiyoda-ku, Tokyo (JP)

(73) Assignee: Hitachi Automotive Systems, Ltd., Hitachinaka-shi, Ibaraki (JP)

(21) Appl. No.: 16/638,045

(22) PCT Filed: Jul. 18, 2018
(86) PCT No.: PCT/JP2018/026820

§ 371 Date: Feb. 10, 2020

(30) Foreign Application Priority Data
Aug. 30, 2017 (JP) 2017-165560

(51) Int. Cl. B60T 8/1755; B60T 8/171; G05D 1/08

(52) U.S. Cl. CPC B60T 8/17551; B60T 8/171; G05D 2201/0213; G05D 1/0891; B60T 8/17554

(57) ABSTRACT

Provided is a vehicle control device that can reduce an uncomfortable feeling imparted to the driver when yaw-moment control is executed. In accordance with the output of a computation unit that instructs a yaw moment, the vehicle control device changes the distribution ratio between the braking force imparted to the front wheels and the braking force imparted to the rear wheels.

### TECHNICAL FIELD

The present invention relates to a vehicle control device that controls action of a vehicle.

### BACKGROUND ART

In vehicle control, yaw moment (rotational force about a z-axis) is generated by controlling braking force on wheels, thereby promoting or stabilizing a lateral motion of the vehicle. Such control is called yaw moment control.

PTL 1 describes the yaw moment control. PTL 1 aims at “providing a vehicle motion control device that can improve maneuverability, stability, and riding comfort”. PTL 1 discloses a technique of “a vehicle motion control device including control means for independently controlling driving force of each wheel of the vehicle, acceleration and deceleration command calculation means for calculating an acceleration and deceleration command value based on lateral jerk, first yaw moment command calculation means for calculating a first vehicle yaw moment command value based on the lateral jerk, and second yaw moment command calculation means for calculating a second yaw moment command value based on side slip information, the vehicle motion control device having a first mode in which acceleration and deceleration are controlled by generating substantially the same driving force for the left and right wheels of four wheels based on the acceleration and deceleration command value, a second mode in which the yaw moment is controlled by generating the different driving force between the left and right wheels of the four wheels based on the first yaw moment command value, and a third mode in which the yaw moment is controlled by generating different driving forces between the left and right wheels of the four wheels based on the second yaw moment command value (see abstract).

### CITATION LIST

### Patent Literature

PTL 1: JP 2014-069766 A

### SUMMARY OF INVENTION

### Technical Problem

Usually a braking force distribution between the front and rear wheels is previously fixed in the conventional yaw moment control. Even in PTL 1, the braking force distribution between the front and rear wheels is not particularly considered. However, according to the study of the present inventors, it has been found that when the yaw moment control is executed, a behavior that gives an uncomfortable feeling to the driver is generated depending on the braking force distribution between the front and rear wheels.

The present invention has been made in view of the above problems, and provides a vehicle control device that can prevent the uncomfortable feeling given to the driver when the yaw moment control is executed.

### Solution to Problem

A vehicle control device according to the present invention changes a distribution ratio between braking force for a front wheel and braking force for a rear wheel according to output of an arithmetic unit that issues instruction of yaw moment.

### Advantageous Effects of Invention

According to the vehicle control device of the present invention, the uncomfortable feeling given to the driver can be prevented while the yaw moment control is executed using the braking force on the wheels.

### BRIEF DESCRIPTION OF DRAWINGS

FIG. 1 is a view illustrating a specific traveling example to which G-Vectoring control is applied.

FIG. 2 is a view illustrating a steering angle, lateral acceleration, lateral jerk, a longitudinal acceleration command calculated using an equation 1, and braking and driving forces of four wheels as a time calendar waveform.

FIG. 3 is a view illustrating the relationship among an increase or decrease in lateral acceleration, a longitudinal acceleration command value G_{xc} of G-Vectoring control, and target yaw moment M_{z_GVC} by M+ control.

FIG. 4 is a view illustrating physical parameters acting on a vehicle when the M+ control is executed.

FIG. 5 is a block diagram illustrating a vehicle control device 100 according to a first embodiment.

FIG. 6 is a flowchart illustrating action of a braking force controller 130.

FIG. 7 is a flowchart illustrating the action of the braking force controller 130 in a second embodiment.

### DESCRIPTION OF EMBODIMENTS

### <Outline of G-Vectoring Control and Yaw Moment Control>

Before description of a vehicle motion control device according to an embodiment of the present invention, for a better understanding of the present invention, an outline of the longitudinal motion control (G-Vectoring control) and the yaw moment control (M+ control), which are linked with the lateral motion, and a combination of the both will be described below. In the following description, when a center of gravity of a vehicle is set to an origin, when a longitudinal direction of the vehicle is set to x, and when a direction (a lateral (left-and-right) direction of the vehicle) perpendicular to the longitudinal direction is set to y, acceleration in the x-direction is referred to as longitudinal acceleration and acceleration in the y-direction is referred to as lateral acceleration. In the longitudinal acceleration, a forward direction of the vehicle is set to positive, namely, the longitudinal acceleration that increases speed of the vehicle is set to positive when the vehicle is traveling in the forward direction. In the lateral acceleration, when the vehicle is traveling in the forward direction, the lateral acceleration generated in turning to the left (counterclockwise) is set to positive, and a reverse direction is set to negative. A left-hand turning radius is set to positive, and a reciprocal of the left-hand turning radius is set to a vehicle traveling curvature. Similarly, regarding a target track, the left-hand turning radius is set to positive, and the reciprocal of the left-hand turning radius is set to a target track curvature. A steering angle in the left-hand (counterclockwise) direction is set to positive.

(1) Longitudinal Motion Control Linked with Lateral Motion: G-Vectoring

The G-Vectoring is a method for generating load movement between front and rear wheels to improve vehicle controllability and stability by automatically accelerating and decelerating the vehicle in linkage with the lateral motion due to steering wheel operation. As indicated in the following equation 1, an acceleration and deceleration command value (longitudinal acceleration command value G_{xc}) is basically a value obtained by multiplying a lateral jerk G_{y_dot} by a gain C_{xy} and adding a first-order delay. In the equation 1, G_{y} is vehicle lateral acceleration, G_{y_dot} is a vehicle lateral jerk, C_{xy} is a gain, T is a first-order lag time constant, s is a Laplace operator, and G_{x_DC} is an acceleration and deceleration command that is not linked with the lateral motion. It is confirmed that the G-Vectoring can simulate a part of a linkage control strategy of the lateral motion and the longitudinal motion of an expert driver, and that the controllability and the stability of the vehicle can be improved.

$$\begin{matrix}[ Mathematical Formula 1 ] & \\ {G}_{x c} = - sgn ( {G}_{y} \cdot {G}_{y \_ dot} ) \frac{{C}_{x y}}{( 1 + T s )} \vert {G}_{y \_ dot} \vert + {G}_{x \_ DC} & ( 1 )\end{matrix}$$

G_{x_DC} is a deceleration component (offset) that is not linked with the lateral motion, and is a term that is necessary for predictive deceleration when a corner exists ahead or existence of a section speed command. An sgn (signum) term is a term that is provided such that the above action can be obtained with respect to both a right corner and a left corner. Specifically, the action of the deceleration during turn-in at start of steering, stop of the deceleration when the vehicle becomes a steady turn (because the lateral jerk becomes zero), and the acceleration during exit from the corner at the start of steering return can be executed.

For the vehicle control according to the equation 1, when combined acceleration (denoted as G) of the longitudinal acceleration and the lateral acceleration is expressed in a diagram in which a horizontal axis represents the longitudinal acceleration of the vehicle while a vertical axis represents the lateral acceleration of the vehicle, the combined acceleration G makes a curved transition over time (Vectoring). Thus, this control method is called “G-Vectoring control”.

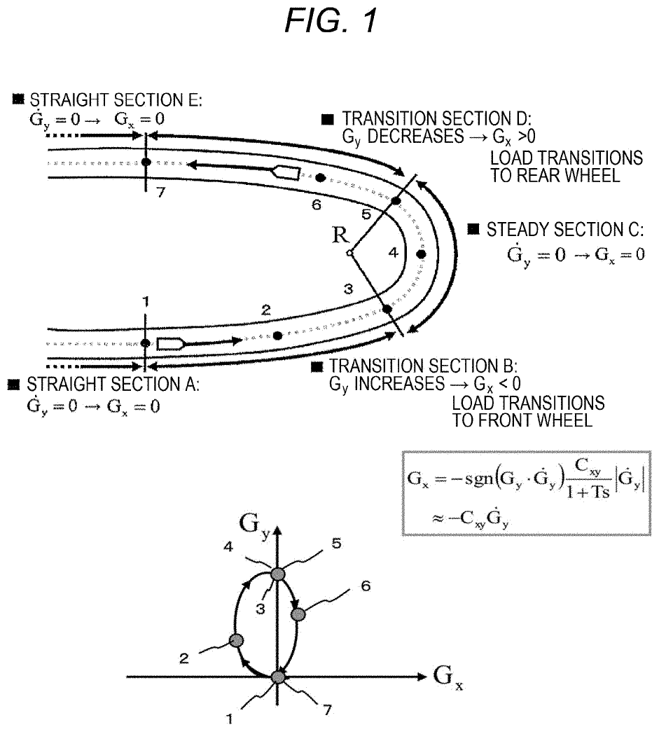

FIG. 1 is a view illustrating a specific traveling example to which the G-Vectoring control is applied. In this case, a general traveling scene with entry into and exit from the corner is assumed. The traveling track in FIG. 1 includes a straight section A, a transition section B, a steady turning section C, a transition section D, and a straight section E. In FIG. 1, it is assumed that the driver does not execute acceleration and deceleration operations.

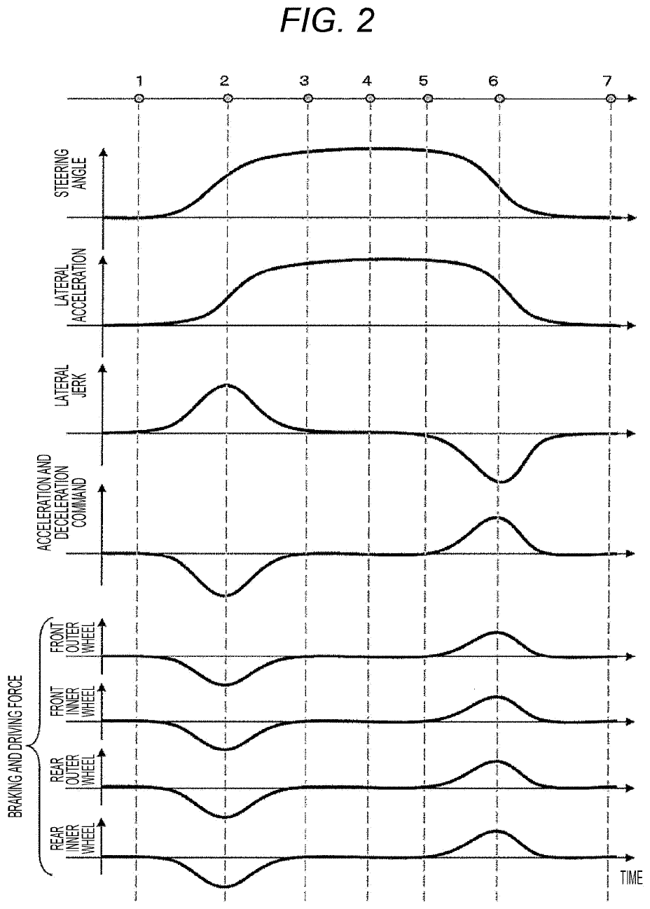

FIG. 2 is a view illustrating the steering angle, the lateral acceleration, the lateral jerk, the longitudinal acceleration command calculated using the equation 1, and braking and driving forces of four wheels as a time calendar waveform. As described in detail later, the braking force and the driving force are distributed such that a front outer wheel and a front inner wheel, and a rear outer wheel and a rear inner wheel have the same value on the left and right (inner and outer). The braking and driving force is a general term for force generated in the vehicle longitudinal direction of each wheel. The braking force is defined as force in a decelerating direction of the vehicle, and the driving force is defined as force in an accelerating direction of the vehicle. In FIGS. 1 and 2, the lateral acceleration G_{y} generated during the left turn of the vehicle is set to positive, and the longitudinal acceleration Gₓ in the forward traveling direction of the vehicle is set to positive. In the force generated in each wheel, the driving force is set to positive, and the braking force is set to negative.

First, the vehicle enters the corner from the straight section A. In the transition section B (points 1 to 3), the lateral acceleration G_{y} of the vehicle increases as the driver gradually turns the steering. The lateral jerk G_{y_dot} takes a positive value while the lateral acceleration in a vicinity of the point 2 increases (returns to zero at the point of time 3 the increase in lateral acceleration ends). At this point, from the equation 1, a deceleration command is issued to the vehicle as the lateral acceleration G_{y} increases (G_{xc} is negative). According to the deceleration command, the braking force (minus sign) having substantially the same magnitude is applied to the front outer, front inner, rear outer, and rear inner wheels.

When the vehicle enters the steady turning section C (points 3 to 5), the driver stops the increase of the steering and keeps the steering angle constant. At this point, because the lateral jerk G_{y_dot} becomes zero, the longitudinal acceleration command value G_{xc} becomes zero. Thus, the braking force and the driving force of each wheel also become zero.

In the transition section D (points 5 to 7), the lateral acceleration G_{y} of the vehicle decreases due to a driver's turning back operation of the steering. At this point, the lateral jerk G_{y_dot} of the vehicle is negative, and the positive longitudinal acceleration command value G_{xc} (acceleration command) is generated in the vehicle from the equation 1. According to the generation of the positive longitudinal acceleration command value G_{xc}, the driving force (positive sign) having substantially the same magnitude is applied to the front outer, front inner, rear outer, and rear inner wheels.

In the straight section E, the lateral acceleration G_{y} becomes zero and the lateral jerk G_{y_dot} also becomes zero, so that the acceleration and deceleration control is not executed.

As described above, the vehicle decelerates from the turn-in at the start of the steering (point 1) to a clipping point (point 3), stops the deceleration during steady circular turning (points 3 to 5), and accelerates during the exit from the corner (point 7) from the start of the turning back of the steering (point 5). In this way, when the G-Vectoring control is applied to the vehicle, the driver can provide the acceleration and deceleration motion linked with the lateral motion only by steering for turning.

When an acceleration mode generated in the vehicle in FIGS. 1 and 2 is illustrated in a diagram (“g-g” diagram) in which the longitudinal acceleration is taken on the horizontal axis while the lateral acceleration is taken on the vertical axis, the g-g diagram becomes characteristic motion in which a smoothly curved transition (drawing a circle) is made. In the g-g diagram, the acceleration and deceleration command of the present invention is generated so as to make the curved transition over time. In the curved transition, a clockwise transition is made for the left corner as illustrated in FIG. 1, and for the right corner, a transition path obtained by inverting the clockwise transition with respect to a Gₓ axis and the transition direction becomes a half clockwise direction. By making the transition, pitching motion generated in the vehicle by the longitudinal acceleration and roll motion generated by the lateral acceleration are suitably linked with each other, and peak values of a roll rate and a pitch rate are reduced.

In this control, as indicated by the equation 1, when the first-order lag term and a sign function for the left-and-right motion are omitted, a value obtained by multiplying the vehicle lateral jerk by the gain C_{xy} is used as the longitudinal acceleration command. Thus, even if the lateral jerk is the same, the deceleration or the acceleration can be increased by increasing the gain C_{xy}.

### (2) Yaw Moment Control Based on G-Vectoring: Moment Plus (M+)

M+ control is a method for improving promotion or stability of yaw motion by giving the same effect as the promotion or stabilization of the yaw motion due to the acceleration and deceleration of the G-Vectoring control by a difference in braking and driving force generated on the left and right wheels of the vehicle. Specific target yaw moment M_{z_GVC} is given by the following equation 2. Cₘₙ is a proportional coefficient, and Tₘₙ is a first-order delay time constant.

$$\begin{matrix}[ Mathematical Formula 2 ] & \\ {M}_{z \_ GVC} = sgn ( {G}_{y} \cdot {G}_{y \_ dot} ) \frac{{C}_{mn}}{( 1 + {T}_{mn} s )} \vert {G}_{y \_ dot} \vert & ( 2 )\end{matrix}$$

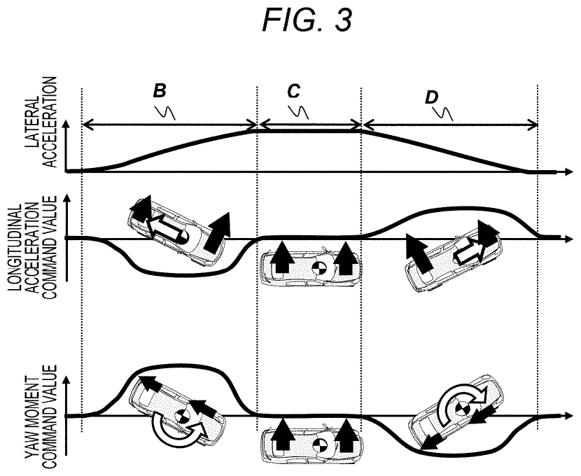

FIG. 3 is a view illustrating the relationship among the increase or decrease in lateral acceleration, the longitudinal acceleration command value G_{xc} of the G-Vectoring control, and the target yaw moment M_{z_GVC} by the M+ control. In FIG. 3, the left-hand yaw moment about the center of gravity of the vehicle is set to positive.

In the section B where the lateral acceleration increases, the G-Vectoring control generates the negative longitudinal acceleration command value (that is, decelerating the vehicle), and the yaw motion after the start of turning is promoted by a lateral force difference between the vehicle front and rear wheels with the movement of the load. On the other hand, the M+ control promotes the yaw motion by directly generating yaw moment about the center of gravity due to a difference in braking and driving force between the left and right wheels of the vehicle (the braking force is generated only on the left wheel of the vehicle in FIG. 3).

In the steady turning section C where the lateral motion is kept constant, the command value is zero for both the G-Vectoring control and the M+ control. In section D where the lateral acceleration decreases, the G-Vectoring control generates the positive longitudinal acceleration command value (that is, accelerating the vehicle), and stabilizes the yaw motion after the start of turning by the lateral force difference between the vehicle front and rear wheels with the movement of the load. On the other hand, the M+ control stabilizes the yaw motion by directly generating the yaw moment about the center of gravity due to the difference in braking and driving force between the left and right wheels of the vehicle (the braking force is generated only on the right wheel of the vehicle in FIG. 3).

As described above, the G-Vectoring control and the M+ control generate the longitudinal acceleration command value and the yaw moment command value, respectively such that the yaw motion is promoted in the section where the absolute value of the lateral acceleration increases, and such that the yaw motion is stabilized in the section where the absolute value of the lateral acceleration decreases.

### (3) Combination of G-Vectoring Control and M+ Control

When the braking and driving of the four wheels can be controlled independently, the longitudinal acceleration generated by the M+ control is equalized to the longitudinal acceleration command value of the G-Vectoring control, so that the M+ control and the G-Vectoring control cannot interfere with each other. Specifically, a total value FwL of the braking and driving force generated on the left front and rear wheels and a total value FwR of the braking and driving force generated on the right front and rear wheels may be determined such that the yaw moment generated by a difference between the total value FwL and the total value FwR becomes the yaw moment command value of the M+ control, and such that the longitudinal acceleration generated by the sum of the total value FwL and the total value FwR becomes the longitudinal acceleration command value of the G-Vectoring control.

### <Influence of Braking Force Distribution Ratio of Front and Rear Wheels in M+ Control>

A suspension provided in the vehicle is a mechanism that improves ride quality and handling stability by stabilizing a posture of the vehicle. In the vehicle including front wheel-side and rear wheel-side suspensions having anti-dive geometry and anti-lift geometry, respectively, for example, when the braking force is applied to the vehicle while the vehicle is traveling forward, the force to direct the vehicle upward acts on the front wheel side, the force to direct the vehicle downward acts on the rear wheel side, and these can stabilize the posture of the vehicle.

Because the M+ control generates the yaw moment by applying the braking force of the wheel, the braking force by the M+ control is applied in addition to the brake operated by the driver. At this point, sometimes the driver feels uncomfortable depending on the braking force distribution ratio between the front and rear wheels. The reason will be described below.

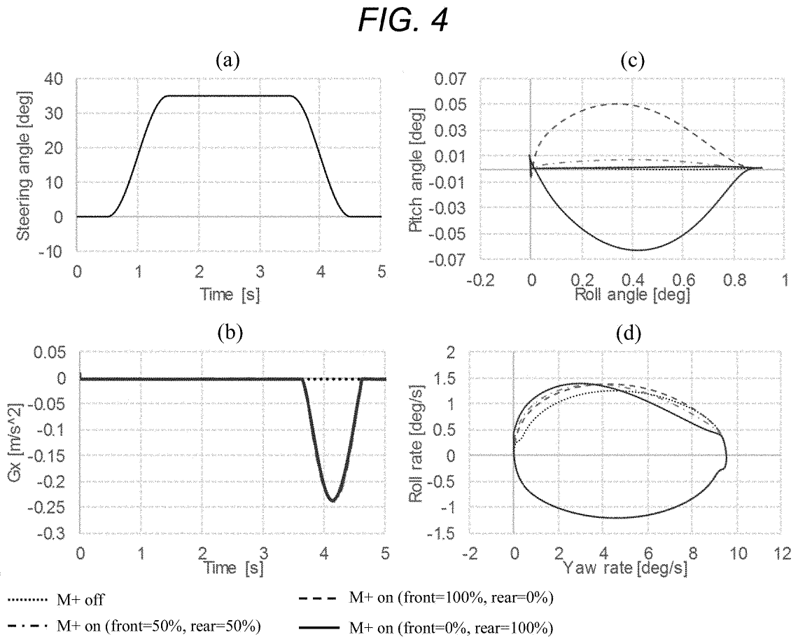

FIG. 4 is a view illustrating physical parameters acting on the vehicle when the M+ control is executed. FIG. 4(a) illustrates a change in steering angle. At this point, the direction in which the handle is rotated to the left is set to positive. As illustrated in FIG. 4(a), in the following description, it is assumed that the driver fixes the steering wheel while turning the steering wheel to the left and then returns the steering wheel.

FIG. 4(b) illustrates the deceleration caused by the M+ control. An example in which the yaw moment is generated to stabilize the vehicle when the steering wheel is returned to the original position is illustrated in FIG. 4(b). Thus, in FIG. 4(b), the deceleration is generated due to the M+ control when the steering angle returns to the original value.

FIG. 4(c) illustrates a change with time in a pitch angle (rotation angle about the left-and-right direction of the vehicle) and a roll angle (rotation angle about the front-rear direction of the vehicle). At this point, it is assumed that both front and rear wheels of the vehicle include the suspension. The direction in which the vehicle leans forward is set to positive. When the M+ control is not executed, the pitch angle hardly changes as the steering angle changes as indicated by a dotted line. On the other hand, when the M+ control is executed, it is assumed that the vehicle leans forward by the braking force. It is considered that such a behavior will be expected by the driver.

A broken line indicates the case where the distribution ratio between the braking force of the front wheels and the braking force of the rear wheels is set to 100% for the front wheel and 0% for the rear wheel after the M+ control is executed. It can be seen that the vehicle leans forward by the braking force.

A solid line is obtained when the braking force distribution ratio is set to 0% for the front wheels and 100% for the rear wheels after the M+ control is executed. In this case, it can be seen that the front of the vehicle is inclined in the direction in which the vehicle rises despite the action of the braking force. It is considered that such a behavior gives an uncomfortable feeling to the driver.

An alternate long and short dash line is obtained when the braking force distribution ratio is set to 50% for the front wheels and 50% for the rear wheels after the M+ control is executed. In this case, because the vehicle hardly leans forward although the braking force is acting, the driver hardly obtains a sense that the vehicle is decelerating, which also gives the uncomfortable feeling to the driver.

FIG. 4(d) illustrates a change with time in the roll rate and the yaw rate (rotational speed about the vertical direction of the vehicle). An upper right part of FIG. 4(d) corresponds to a period during which the M+ control is executed. When the driver turns the steering wheel back, the roll angle of the vehicle is expected to return to zero as the steering wheel rotates. On the other hand, as illustrated in the upper right part of FIG. 4(d), when the M+ control is executed, the change in the roll angle tends to be delayed as the braking force distribution of the rear wheels increases. When the change in the roll angle is delayed, it is considered that the driver feels uncomfortable because the driver feels that the vehicle rolls after the steering wheel is turned back.

As described above, when the braking force distribution of the rear wheels is large in executing M+ control, it is difficult for the driver to get a sense that the vehicle decelerates, and a sense that the vehicle rolls after the handle is returned, thereby giving the uncomfortable feeling to the driver. For this reason, in the present invention, the braking force distribution of the front wheels is increased in executing the M+ control.

The example in which the M+ control is executed while the steering wheel is turned back is described in FIG. 4. However, sometimes the lateral motion of the vehicle is promoted by executing the M+ control in the period in which turning of the steering wheel is started. Even in this case, the driver feels uncomfortable similarly to FIGS. 4(c) and 4(d). For example, in a lower left portion of FIG. 4(d), the roll rate is delayed as the braking force distribution of the rear wheel is increased. Thus, even in this case, the braking force of the front wheel may be increased larger than the braking force of the rear wheel.

### First Embodiment

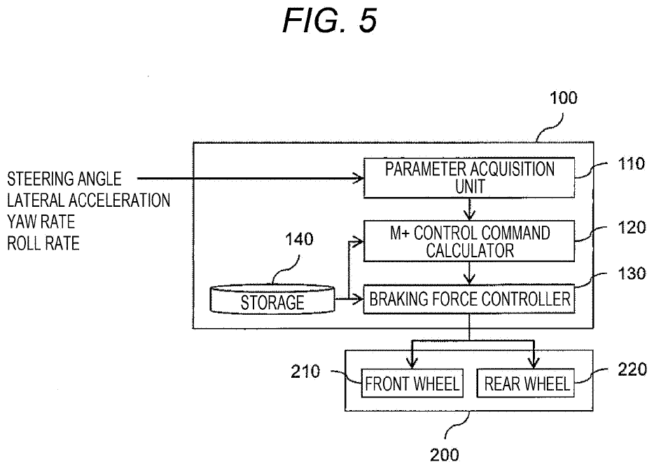

FIG. 5 is a block diagram illustrating a vehicle control device 100 according to a first embodiment of the present invention. The vehicle control device 100 is a device that controls action of the vehicle, and is mounted on the vehicle that is a control target. The vehicle control device 100 includes a parameter acquisition unit 110, an M+ control command calculator 120, a braking force controller 130, and a storage 140.

The parameter acquisition unit 110 acquires a parameter representing the lateral motion of the vehicle. Examples of the parameter representing the lateral motion of the vehicle include the steering angle of the vehicle, the lateral acceleration, the yaw rate, and the roll rate. For example, these parameters can be acquired from sensors provided in the vehicle. Alternatively, when the parameter is obtained by calculation, the parameter acquisition unit 110 may calculate and obtain the parameter.

The M+ control command calculator 120 calculates a command value of the M+ control based on the parameters acquired by the parameter acquisition unit 110. For example, as illustrated in FIGS. 4(a) and 4(b), when the steering wheel is turned back, a control command is generated so as to generate the yaw moment stabilizing the vehicle. Alternatively, a control command that generates the yaw moment accelerating the lateral motion of the vehicle is calculated when starting to turn the steering wheel.

The braking force controller 130 controls the braking force acting on each of a front wheel 210 and a rear wheel 220 by controlling an actuator 200 according to the control command calculated by the M+ control command calculator 120. Additionally, the braking force controller 130 controls the actuator 200 according to, for example, a brake operation of the driver. The detailed action of the braking force controller 130 will be described later.

The storage 140 is a storage device that stores data used by the vehicle control device 100. For example, the distribution ratio between the braking force of the front wheel and the braking force of the rear wheel can previously be stored in the storage 140.

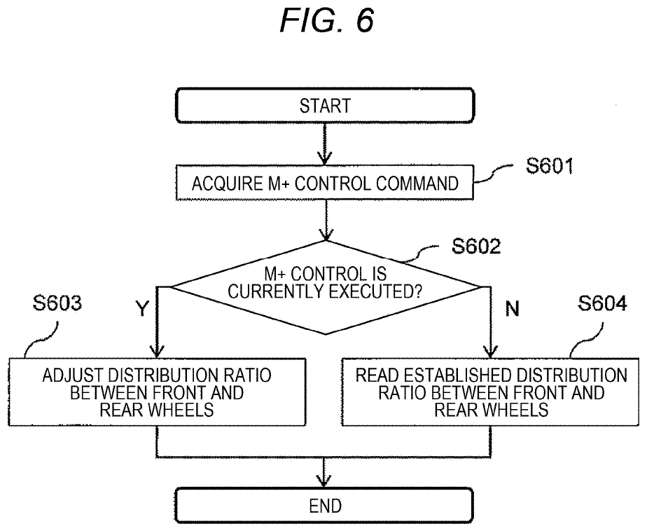

FIG. 6 is a flowchart illustrating the action of the braking force controller 130. The braking force controller 130 repeatedly executes the flowchart in FIG. 6, for example, in each predetermined period. Each step in FIG. 6 will be described below.

### (Steps S601 and S602 in FIG. 6)

The braking force controller 130 acquires the command value of the M+ control from the M+ control command calculator 120 (S601). The process proceeds to step S603 when the M+ control is currently executed, and the process proceeds to step S604 when the M+ control is not executed (S602).

### (Step S603 in FIG. 6)

The braking force controller 130 reads the braking force distribution ratio used during the execution of the M+ control from the storage 140. For example, the distribution ratio in which the braking force distribution of the front wheel is larger than the braking force distribution of the rear wheel, such as the front wheel of 80% and the rear wheel of 20%, is previously stored in the storage 140, and the braking force controller 130 reads the distribution ratio to determine the braking force of each of the front wheel 210 and the rear wheel 220. Because the optimal braking force distribution during the M+ control depends on specifications of the vehicle, an optimal value is previously stored in the storage 140 according to the specification of the vehicle on which the vehicle control device 100 is mounted, and the braking force controller 130 uses the optimal value.

### (Step S604 in FIG. 6)

The braking force controller 130 reads the braking force distribution ratio used when the M+ control is not executed from the storage 140. Similarly to step S603, a predetermined distribution ratio is previously stored in the storage 140, and the braking force controller 130 reads the determined distribution ratio to determine the braking force of each of the front wheel 210 and the rear wheel 220.

### <Summary of First Embodiment>

The vehicle control device 100 of the first embodiment increases the braking force distribution of the front wheel as compared with the braking force distribution of the rear wheel while the M+ control is executed. Consequently, the uncomfortable feeling given to the driver during the M+ control can be prevented. Specifically, the pitch angle at which the front of the vehicle rises as described in FIG. 4(c) and the delay of the roll rate as described in FIG. 4(d) can be prevented.

### Second Embodiment

The brake is generally configured such that the braking force is actuated by a brake fluid pressure. Because the front wheel requires the braking force larger than that of the rear wheel, the braking force of the front wheel tends to rise more slowly even if the propagation of the brake fluid pressure is uniform between the front wheel and the rear wheel. There is a possibility that this becomes an obstacle when the braking force is desired to increase quickly. An example of action to switch whether to give priority to rise of the braking force in consideration of such characteristics of the brake will be described in the second embodiment of the present invention. Because the configuration of the vehicle control device 100 is the same as that of the first embodiment, the following description will focus on a different point.

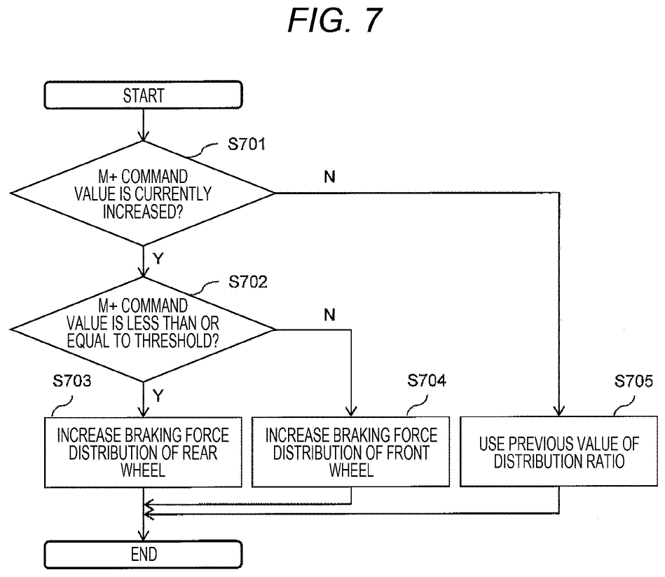

FIG. 7 is a flowchart for explaining the action of the braking force controller 130 in a second embodiment. For example, the braking force controller 130 starts the flowchart in FIG. 7 after completing the flowchart in FIG. 6. Each step in FIG. 7 will be described below.

### (Step S701 in FIG. 7)

The braking force controller 130 acquires the command value of the M+ control from the M+ control command calculator 120. The process proceeds to step S702 when an absolute value of the control command is currently increased (the absolute value of the command value of the yaw moment is currently increased), and the process proceeds to step S705 when the absolute value of the control command is not increased. The case where the absolute value of the control command is currently increased corresponds to a scene in which the M+ control command calculator 120 increases an effect of the M+ control from now on.

### (Step S702 in FIG. 7)

The braking force controller 130 determines whether the command value of the M+ control is less than or equal to a threshold. For example, the threshold may previously be stored in the storage 140. The process proceeds to step S703 when the command value is less than or equal to the threshold, and the process proceeds to step S704 when the command value exceeds the threshold.

### (Step S703 in FIG. 7)

The braking force controller 130 readjusts the braking force distribution ratio determined in step S603 of FIG. 6 to increase the braking force distribution of the rear wheel. For example, when the front wheel is set to 80% while the rear wheel is set to 20% in step S603, the distribution of the rear wheel is increased, such as the front wheel of 50% and the rear wheel of 50%, in step S703.

### (Steps S702 and S703 in FIG. 7: Supplement 1)

When the command value of the M+ control is less than or equal to the threshold, the yaw moment generated by the M+ control is small. In this case, because the uncomfortable feeling given to the driver as described with reference to FIG. 4 is considered to be small, emphasis is placed on quickly start of the braking force, and the braking force distribution of the rear wheel in which the braking force is likely to rise is increased.

### (Steps S702 and S703 in FIG. 7: Supplement 2)

A specific value of the threshold in step S702 depends on the characteristics of the vehicle. This is because a rising speed of the braking force of each of the front and rear wheels and a degree of uncomfortable feeling given to the driver vary in each vehicle. Thus, an optimal threshold is determined according to the characteristics of the vehicle on which the vehicle control device 100 is mounted, and previously stored in the storage 140, and the braking force controller 130 reads the threshold and uses the threshold in step S702.

### (Step S704 in FIG. 7)

The braking force controller 130 controls the braking force for each of the front wheel 210 and the rear wheel 220 using the distribution ratio of the braking force determined in step S603 of FIG. 6. In this case, the braking force distribution ratio of the front wheel 210 is increased more than that of the rear wheel 220.

### (Step S705 in FIG. 7)

The braking force controller 130 controls the braking force for each of the front wheel 210 and the rear wheel 220 using the previous value of the distribution ratio. Specifically, the distribution ratio determined in step S603 is used while the M+ control is executed, and the distribution ratio determined in step S604 is used otherwise.

### <Summary of Second Embodiment>

When the command value of the M+ control is small, the vehicle control device 100 of the second embodiment places importance on the quick rise of the braking force, and the braking force distribution of the rear wheel is increased more than that in step S603. Consequently, the braking force of the vehicle can be stabilized while the uncomfortable feeling given to the driver is prevented.

### <Modifications of the Present Invention>

The present invention is not limited to the above embodiments, but includes various modifications. For example, the above embodiments are described in detail for the purpose of easy understanding of the present invention, and do not necessarily include all the described configurations.

In the above embodiments, the parameter acquisition unit 110, the M+ control command calculator 120, and the braking force controller 130 can be configured using hardware such as a circuit device that implements these functions, or can also be configured by software that implements the function executed by an arithmetic unit.

In the second embodiment, by way of example, the flowchart in FIG. 7 is performed after the flowchart in FIG. 6. However, the flowchart in FIG. 7 can also be used alone. In this case, in step S704, the distribution ratio obtained by increasing the braking force distribution of the front wheel may previously be stored in the storage 140, and the braking force controller 130 may read and use the distribution ratio.

The yaw moment control (M+ control) based on the G-Vectoring control and the combination thereof are described in the above embodiments. However, the present invention can be applied in other control techniques of controlling the yaw moment by controlling the braking force of the wheel.

### REFERENCE SIGNS LIST

100 vehicle control device
110 parameter acquisition unit
120 M+ control command calculator
130 braking force controller
140 storage
200 actuator
210 front wheel
220 rear wheel

1. A vehicle control device that controls action of a vehicle, the vehicle control device comprising:
a lateral motion parameter acquisition unit that acquires a parameter representing a lateral motion of the vehicle;
an arithmetic unit that issues instruction of yaw moment acting on the vehicle based on the parameter acquired by the lateral motion parameter acquisition unit; and
a braking force controller that controls braking force of the vehicle according to output of the arithmetic unit,
wherein the braking force controller changes a distribution ratio between the braking force for a front wheel of the vehicle and the braking force for a rear wheel of the vehicle according to the output of the arithmetic unit.

2. The vehicle control device according to claim 1, wherein
the arithmetic unit calculates a control command instructing the yaw moment,
the braking force controller generates the yaw moment designated by the control command by controlling the braking force for the front wheel included in the vehicle and the braking force for the rear wheel included in the vehicle, and
the braking force controller determines the distribution ratio of the braking force between the front wheel and the rear wheel such that the braking force for the front wheel of the vehicle is greater than the braking force for the rear wheel of the vehicle while the yaw moment is generated according to the control command.

3. The vehicle control device according to claim 2, wherein
the arithmetic unit calculates a stabilization yaw moment command as the control command in a period in which an absolute value of lateral acceleration of the vehicle decreases from a value larger than zero toward zero, the stabilization yaw moment command stabilizing the lateral motion of the vehicle by generating the braking force on an outer wheel side of the vehicle, and
the braking force controller determines the distribution ratio of the braking force between the front wheel and the rear wheel such that the braking force for the front wheel of the vehicle is greater than the braking force for the rear wheel of the vehicle while the arithmetic unit calculates the stabilization yaw moment command.

4. The vehicle control device according to claim 2, wherein
the arithmetic unit calculates a promotion yaw moment command as the control command in a period in which an absolute value of lateral acceleration of the vehicle increases from zero, the promotion yaw moment command promoting the lateral motion of the vehicle by generating the braking force on an inner ring side of the vehicle, and
the braking force controller determines the distribution ratio of the braking force between the front wheel and the rear wheel such that the braking force for the front wheel of the vehicle is greater than the braking force for the rear wheel of the vehicle while the arithmetic unit calculates the promotion yaw moment command.

5. The vehicle control device according to claim 2, further comprising a storage that stores a threshold for comparison to a value of the control command,
wherein
the braking force controller compares the value of the control command to the threshold while the absolute value of the control command calculated by the arithmetic unit increases, and
the braking force controller readjusts the braking force between the front wheel and the rear wheel such that a rate of the braking force of the rear wheel is greater than the determined distribution ratio when the absolute value of the control command is increasing and when the absolute value of the control command is less than or equal to the threshold.

6. The vehicle control device according to claim 5, wherein the braking force controller determines the braking force for the front wheel of the vehicle and the braking force for the rear wheel of the vehicle according to the determined distribution ratio when the absolute value of the control command is increasing and when the absolute value of the control command is greater than the threshold.

7. The vehicle control device according to claim 5, wherein the braking force controller determines the braking force for the front wheel of the vehicle and the braking force for the rear wheel of the vehicle according to the determined distribution ratio when the absolute value of the control command is not increasing.

8. The vehicle control device according to claim 2, wherein
the arithmetic unit switches between a period in which the control command is calculated and a period in which the control command is not calculated according to a change in the parameter, and
the braking force controller returns the distribution ratio to an original value when the arithmetic unit is shifted to a period in which the control command is not calculated after the distribution ratio is changed.
